(19) United States
(12) Patent Application Publication
(10) Pub. No.: US 2026/0259134 A1
(43) Pub. Date: Sep. 3, 2026

(54) OPTICAL ANALYSIS DEVICE

(71) Applicant: EBARA JITSUGYO CO., LTD., Tokyo (JP)

(72) Inventor: Takashi NOGUCHI, Kanagawa (JP)

(21) Appl. No.: 19/165,430

(22) PCT Filed: Jan. 23, 2024
(86) PCT No.: PCT/JP2024/001782

§ 371 Date: Sep. 15, 2025

(30) Foreign Application Priority Data
Mar. 17, 2023 (JP) 2023-043392

(51) Int. Cl. G01N 21/3504; G01N 21/05; G01N 21/25; G01N 21/27; G01N 21/33

(52) U.S. Cl. CPC G01N 21/3504; G01N 21/05; G01N 21/255; G01N 21/274; G01N 21/33; G01N 2201/1211; G01N 2201/1218

(57) ABSTRACT

An optical analysis device includes: a measuring cell in a gas supply line; a semiconductor light source apart from the measuring cell; a drive unit; a distributor branching light from the semiconductor light source into transmitted light radiating a substance to be measured in the measuring cell and incident light not passing through the measuring cell; a transmitted light detector detecting the transmitted light, an incident light detector detecting the incident light, a temperature measuring element measuring a state temperature of the semiconductor light source; a drive unit driving and lighting the semiconductor light source; and a control unit. The optical analysis device pre-stores a characteristic coefficient of the semiconductor light source in a memory, computes the absorptivity of the substance during measurement in a computing unit by using detected temperature of the semiconductor light source from the temperature measuring element, and calculates a concentration of the substance by absorptiometry.

### CROSS REFERENCE

This application is a 371 U.S. National Phase of International Application No. PCT/JP2024/001782, filed on Jan. 23, 2024, which claims priority to Japanese Patent Application No. 2023-043392, filed on Mar. 17, 2023. The entire disclosures of the above applications are incorporated herein by reference.

### TECHNICAL FIELD

The present invention relates to an optical analysis device that can accurately measure the concentration of a substance to be measured in a measuring cell by absorptiometry using a semiconductor light source. Specifically, the optical analysis device has a measurement accuracy improved by causing the substance to be measured to flow into the measuring cell, measuring the amount of absorption of light emitted to the inside of the measuring cell to calculate an absorbance, and computing a proper absorptivity corresponding to the absorbance based on a state temperature of the semiconductor light source.

### BACKGROUND ART

In conventional optical analysis devices of this type, the concentration of a substance to be measured is determined by using monochromatic light compatible with an absorptivity of the substance to be measured as the light emitted to the substance to be measured (see Patent Literature 1).

### CITATION LIST

### Patent Literature

Patent Literature 1: International Publication No. WO 2020/158506

### Technical Problem

However, in measurement using semiconductor light sources, the semiconductor light sources have wide emission wavelength ranges even among the same type of light sources due to the nature of the semiconductor light sources (unlike heat radiation light sources), and their emission wavelengths change due to the influence of self-heating and ambient temperature. This makes it necessary to calculate a proper absorptivity corresponding to change in wavelength to improve the measurement accuracy. The proper absorptivity herein refers to an absorptivity when a given compound exhibits maximum absorption in a single wavelength, and the absorptivity can be obtained under standard measurement conditions.

Accordingly, as means for restraining the change in emission wavelength, it is common practice to have a temperature control mechanism with such functions as using a heating element or the like to keep the state temperature of the semiconductor light source at a constant temperature. However, in terms of size reduction, structure simplification, power consumption, and high structural cost, the temperature control mechanism is not preferable for optical analyzers. Moreover, the temperature control mechanism is not able to provide the effect of restraining the wide emission wavelength range of the semiconductor light sources.

In in-line optical analysis devices using a semiconductor light source directly interconnected to a main line in a manufacturing process, it is common practice for calibration to remove the in-line optical analysis devices from the interconnection for concentration comparison in their manufacturers. This increases the time required for calibration.

In addition, the semiconductor light sources have large variations in solids in terms of emission wavelength range and temperature characteristics, which makes it necessary to install the light sources in pair with respective optical analysis device bodies and calibrate concentration to improve the measurement accuracy. However, it is said to be difficult to calibrate the concentration of the semiconductor light sources and to replace the light sources at manufacturing sites. Therefore, the measurement accuracy is adversely affected by the variations in emission wavelength range and temperature characteristics caused by using the semiconductor light sources.

Therefore, an object of the present invention is to provide an optical analysis device that can perform more accurate measurement in a shorter time.

### SUMMARY

(1) In order to accomplish the object, an optical analysis device of one embodiment includes: a measuring cell having a flow channel for a substance to be measured to flow; a semiconductor light source that emits light with a wavelength compatible with an absorptivity of the substance to be measured; a transmission window that transmits light from the semiconductor light source; a transmitted light detector that detects transmitted light in the measuring cell, the transmitted light being the light coming from the semiconductor light source and passing through the transmission window; an incident light detector that detects incident light not passing through the measuring cell; a distributor that branches the light into the transmitted light and the incident light; a temperature measuring element that measures a state temperature of the semiconductor light source; a temperature sensor that measures temperature of the substance to be measured; a pressure sensor that measures pressure of the substance to be measured; and a drive unit that lights the semiconductor light source, wherein a characteristic coefficient of the semiconductor light source is stored in a memory in advance, and the absorptivity of the substance to be measured during measurement is computed in a computing unit by using detected temperature of the semiconductor light source from the temperature measuring element, and a concentration of the substance to be measured is calculated by absorptiometry.

(2) In order to accomplish the object, an optical analysis device of another embodiment includes: a measuring cell having a flow channel for a substance to be measured to flow; a semiconductor light source that emits light with a wavelength compatible with an absorptivity of the substance to be measured; a transmission window that transmits light from the semiconductor light source; a transmitted light detector that detects transmitted light in the measuring cell, the transmitted light being the light coming from the semiconductor light source and passing through the transmission window; an incident light detector that detects incident light not passing through the measuring cell; a distributor that branches the light into the transmitted light and the incident light; a temperature sensor that measures temperature of the substance to be measured; a pressure sensor that measures pressure of the substance to be measured; and a drive unit that lights the semiconductor light source, wherein a characteristic coefficient of the semiconductor light source is stored in a memory in advance, the absorptivity of the substance to be measured during measurement is computed in the computing unit by using detected temperature of the semiconductor light source, and a concentration of the substance to be measured is calculated by absorptiometry.

(3) In the optical analysis device of another embodiment, the distributor used to branch the light from the semiconductor light source may preferably be a beam splitter or a diffraction grating.

(4) In the optical analysis device of another embodiment, the transmission window may preferably be made of a sapphire glass material or a quartz glass material.

(5) In the optical analysis device of another embodiment, the temperature measuring element of the semiconductor light source may preferably detect the state temperature of a mounting pad for the semiconductor light source by using any one of a thermometer resistor, a thermistor, a thermocouple, a semiconductor temperature measuring element, and an infrared sensor.

(6) In the optical analysis device of another embodiment, the temperature measuring element of the semiconductor light source may preferably be arranged on a substrate on which the semiconductor light source to detect the state temperature is mounted.

(7) In the optical analysis device of another embodiment, the temperature measuring element of the semiconductor light source may preferably be arranged adjacent to a mounting pad for the semiconductor light source, by using any one of a thermometer resistor, a thermistor, a thermocouple, a semiconductor temperature measuring element, and an infrared sensor, to detect the state temperature through heat transfer due to radiant heat or through contact via a substance with high thermal conductivity.

(8) In the optical analysis device of another embodiment, the temperature measuring element may preferably be arranged adjacent to a substrate on which the semiconductor light source is mounted, and may be configured to detect the state temperature through heat transfer by using any one of a thermometer resistor, a thermistor, a thermocouple, a semiconductor temperature measuring element, and an infrared sensor through radiant heat or through contact via a substance with high thermal conductivity.

(9) In the optical analysis device of another embodiment, the memory may preferably store at least one characteristic coefficient out of a first characteristic coefficient of the semiconductor light source that is a specific peak wavelength when the semiconductor light source is measured at a reference temperature, a second characteristic coefficient of the semiconductor light source that is an absorbance sensitivity calibration ratio indicating a ratio relative to an absorption coefficient calculated from a compatible peak wavelength and the specific peak wavelength of the substance to be measured, a third characteristic coefficient of the semiconductor light source that is a standard sensitivity calibration ratio indicating a ratio between an absorption coefficient of the specific peak wavelength, calculated using a relationship between a standard peak wavelength at the reference temperature and the absorptivity of the substance to be measured, and the absorbance sensitivity calibration ratio, a fourth characteristic coefficient of the semiconductor light source that is an absorbance temperature coefficient indicating a relative coefficient between the standard peak wavelength of the semiconductor light source at the reference temperature and a temperature coefficient in the absorptivity of the substance to be measured, a fifth characteristic coefficient of the semiconductor light source that is a peak wavelength temperature coefficient ratio indicating a relative coefficient between a temperature coefficient in the standard peak wavelength of the semiconductor light source and a temperature coefficient in the specific peak wavelength, a sixth characteristic coefficient of the semiconductor light source that is a proper absorbance temperature coefficient indicating a temperature coefficient ratio calculated from a relationship between an absorbance temperature coefficient ratio in the compatible absorptivity that is an authorized absorptivity enabling the substance to be measured to most efficiently absorb light and the peak wavelength temperature coefficient ratio, and a seventh characteristic coefficient of the semiconductor light source that is a proper absorbance sensitivity coefficient indicating an absorbance sensitivity coefficient of the absorptivity and the compatible absorptivity of the substance to be measured in the specific peak wavelength at the reference temperature.

(10) In the optical analysis device of another embodiment, the computing unit may preferably compute the proper absorptivity of the substance to be measured corresponding to an emission wavelength during measurement using the temperature measuring element that measures the state temperature of the semiconductor light source and the characteristic coefficient of the semiconductor light source.

(11) In the optical analysis device of another embodiment, current, voltage, or frequency of a drive power supply for the semiconductor light source may be varied to optionally change the state temperature of the semiconductor light source and to control an emission wavelength, and a degree of contamination of the transmission window may be computed based on the absorptivity of the substance to be measured corresponding to the emission wavelength to perform zero point calibration.

(12) In the optical analysis device of another embodiment, the semiconductor light source may preferably be attachable and detachable and be configured to allow attachment of a different semiconductor light source.

### Advantageous Effects of Invention

The present invention can provide an optical analysis device that can perform more accurate measurement in a shorter time.

### BRIEF DESCRIPTION OF THE DRAWINGS

FIG. 1 is a diagram showing an overall configuration of a concentration detection system including an optical analysis device 1 used in embodiments of the present invention.

FIG. 2 is a diagram showing the configuration of the optical analysis device 1 used in the embodiments of the present invention.

FIG. 3 is an explanatory view of the effect in an example of the present invention.

### REFERENCE SIGNS LIST

1 optical analysis device
2 semiconductor light source
3 semiconductor manufacturing apparatus
4 measuring cell
7 distributor
8 transmitted light detector
9 incident light detector
10 temperature measuring element
11 temperature sensor
12 pressure sensor
13 light source mounting substrate
14, 34 memory (memory element)
15 drive unit (drive power supply)
16 computing unit
17 control unit
20 inlet port
21 outlet port
22 flow channel
23 transmission window
24 main gas line
25 gas supply device

### DETAILED DESCRIPTION

Embodiments of the present invention will be described below with reference to the drawings. The embodiments described below are not intended to limit the invention according to each of the claims. All the features described in the embodiments and their combinations are not necessarily essential to the means provided by aspects of the invention.

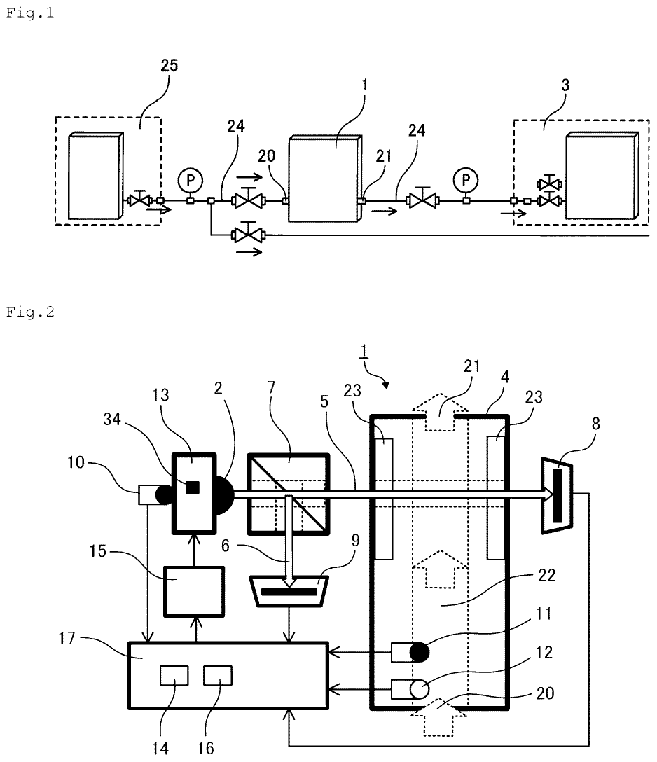

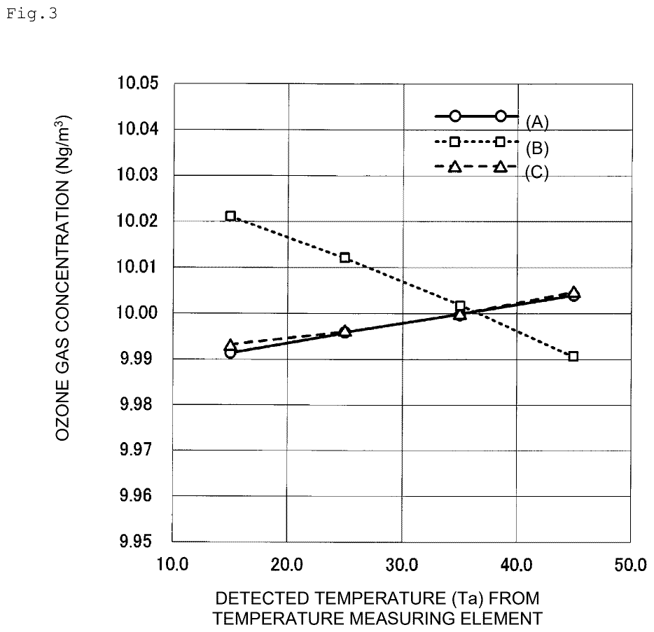

In the present embodiment, FIG. 1 is a diagram showing an overall configuration of a concentration detection system including an optical analysis device 1 used in the embodiments of the present invention. FIG. 2 is a diagram showing the configuration of the optical analysis device 1 used in the embodiments of the present invention. FIG. 3 is an explanatory view of the effect in an example of the present invention.

The optical analysis device 1 is connected to a main gas line 24 for a gas supply device 25 and a semiconductor manufacturing apparatus 3 and is arranged so that a substance to be measured (substance flowing in directions of arrows in FIG. 1) flows in a measuring cell 4 in-line through an inlet port 20 and an outlet port 21 provided at both end portions of the measuring cell 4 (see FIG. 2) that constitutes the optical analysis device 1 to allow measurement of concentration.

### [Optical Analysis Device]

As shown in FIG. 1, the optical analysis device 1 according to the present embodiment includes a measuring cell 4 integrated into a gas supply line; a semiconductor light source 2 arranged apart from the measuring cell 4; a drive unit (light source drive circuit) 15, a transmission window 23 that transmits the light emitted from the semiconductor light source 2 and passing through the measuring cell, a distributor 7 that branches the light emitted from the semiconductor light source 2 into transmitted light 5 that irradiates the substance to be measured in the measuring cell 4 and incident light 6 not passing through the measuring cell 4, a transmitted light detector 8 that detects the transmitted light, an incident light detector 9 that detects the incident light, a temperature measuring element 10 that measures a state temperature of the semiconductor light source 2, a temperature sensor 11 that measures the temperature of the substance to be measured, a pressure sensor 12 that measures the pressure of the substance to be measured, the drive unit 15 that drives and lights the semiconductor light source 2, and a control unit 17.

The distributor 7 is a beam splitter or a diffraction grating used for branching the light from the semiconductor light source 2. As the transmission window 23, sapphire is suitably used, as sapphire is resistant to detection light used for concentration measurement, such as ultraviolet light, and has high transmittance of the detection light as well as mechanical and chemical stability, though other stable materials, such as quartz glass, can also be used.

The temperature measuring element 10 is configured to detect a state temperature of a mounting pad for the semiconductor light source 2 by using a thermometer resistor, a thermistor, a thermocouple, a semiconductor temperature measuring element, an infrared sensor, or the like. Here, the temperature measuring element 10 may be arranged on a substrate on which the semiconductor light source 2 is mounted and be configured to detect the state temperature. The temperature measuring element 10 may also be arranged adjacent to the mounting pad for the semiconductor light source 2, by using the thermometer resistor, the thermistor, the thermocouple, the semiconductor temperature measuring element, the infrared sensor or the like, and be configured to detect the state temperature through heat transfer through radiant heat or through contact via a substance with high thermal conductivity. The temperature measuring element 10 may also be arranged adjacent to the substrate on which the semiconductor light source is mounted and be configured to detect the state temperature through heat transfer through radiant heat or through contact via a substance with high thermal conductivity.

Without providing the temperature measuring element 10, a potential difference (forward voltage) between an anode electrode and a cathode electrode of a diode constituting the semiconductor light source 2 may be detected, and the state temperature of the mounting pad for the semiconductor light source 2 may be detected based on the detected potential difference. In that case, temperature information based on the potential difference between the anode electrode and the cathode electrode in the diode is stored in the memory (memory element) 14. In this case, the temperature measuring element is not required, so that a simpler configuration is implemented.

The control unit 17 includes the memory (memory element) 14 that stores detection signals from the transmitted light detector 8 and the incident light detector 9, temperature information acquired in the temperature measuring element 10 (including the temperature information based on the potential difference between the anode electrode and the cathode electrode in the diode described above), and a characteristic coefficient of the semiconductor light source 2. The control unit 17 also includes a computing unit 16 that computes an absorbance using the detection signals from the transmitted light detector 8 and the incident light detector 9 and computes an absorptivity of the substance to be measured in the light emitted from the semiconductor light source 2 using the detection temperature from the temperature measuring element 10. The temperature sensor 11, the pressure sensor 12, the transmitted light detector 8, the incident light detector 9, the temperature measuring element 10, and the drive unit 15 in the measuring cell 4 are electrically connected to the control unit 17 via, for example, an optical fiber and a sensor cable. In the present embodiment, a memory 34, which has the same function as the memory 14 that records a plurality of characteristic coefficients described later, is provided on a light source mounting substrate 13, though it is naturally understood that only one of these memories may be provided.

The memory (memory element) 14 stores (records) a plurality of characteristic coefficients of the semiconductor light source 2 to be used, and more specifically, the memory (memory element) 14 stores at least one out of a specific peak wavelength, an absorbance sensitivity calibration ratio, a standard sensitivity calibration ratio, an absorbance temperature coefficient, a peak wavelength temperature coefficient ratio, a proper absorbance temperature coefficient, and a proper absorbance sensitivity coefficient. The memory (memory element) 14 also stores each formula (computational processing program) that appears in a concentration calculation process described below. In the optical analysis device 1, it is necessary to perform concentration calibration in a manufacturing process and store in the memory 14 a cell sensitivity coefficient in absorbance to compensate for the difference in optical path length of the measuring cell 4. Definitions of the specific peak wavelength, the absorbance sensitivity calibration ratio, the standard sensitivity calibration ratio, the absorbance temperature coefficient, the peak wavelength temperature coefficient ratio, the proper absorbance temperature coefficient, and the proper absorbance sensitivity coefficient are described later.

The drive unit 15 can optionally change the state temperature of the semiconductor light source 2 by varying current, voltage, or frequency of a drive power supply for the semiconductor light source. This makes it possible to optionally control the emission wavelength of light emitted from the semiconductor light source 2 and to perform zero point calibration by computing a degree of contamination of the transmission window 23 in the computing unit 16 based on the absorptivity of the substance to be measured corresponding to the emission wavelength.

### [Measuring Cell]

The measuring cell 4 has the inlet port 20 and the outlet port 21 of measurement gas, and a flow channel 22 extending in a longitudinal direction. A light-transmissive transmission window 23 is provided at both end portions of the measuring cell 4 in a travel direction of the transmitted light. As the transmission window 23, sapphire is suitably used, as sapphire is resistant to detection light such as ultraviolet light used for concentration measurement, and has high transmittance of the detection light and mechanical and chemical stability, though other stable materials, such as quartz glass, can also be used. Herein, light includes ultraviolet rays as well as at least infrared rays and visible rays, and light can also include electromagnetic waves of any wavelength. The term “light-transmissive” means that internal penetration of irradiated light into the measuring cell 4 is high enough to allow measurement of concentration.

The pressure sensor 12 detects the pressure of the substance to be measured (gas) flowing through the measuring cell 4, and the temperature sensor 11 measures the temperature of the substance to be measured. The outputs of the pressure sensor 12 and temperature sensor 11 are input into the computing unit 16 in the control unit 17 via a sensor cable not shown. There may be more than one temperature sensor 11. As the temperature sensor 11, a thermistor or thermocouple can be used in addition to a thermometer resistor.

As light-receiving elements constituting the transmitted light detector 8 and the incident light detector 9, photodiodes and phototransistors are suitably used, for example.

### [Semiconductor Light Source]

The semiconductor light source 2 includes a light-emitting element (LED here) that emits ultraviolet light of a prescribed wavelength, and the light source mounting substrate 13. A prescribed current, voltage, or frequency is output from the drive unit 15 and detected by the transmitted light detector 8 as a detection signal, and based on the detection signal, the intensity of light corresponding to each wavelength component can be measured. As the light-emitting element, a light-emitting element other than LED, such as a laser diode (LD), can also be used. Moreover, the semiconductor light source 2 may be configured to be detachable and attachable. This is because the detachable and attachable semiconductor light source 2 allows easy replacement with a different semiconductor light source during maintenance.

It is also possible to use, as a light source, multiplexed light having a plurality of light components of different wavelengths instead of a single wavelength light source. In this case, two or more light-emitting elements that require a coupler or a frequency analysis circuit may be provided, or incident light may be generated by using any selected light-emitting element out of the provided light-emitting elements. The light emitted by the light-emitting element is not limited to ultraviolet light and may also be visible light or infrared light.

### [Control Unit]

The control unit 17, which is constituted of, for example, a processor (including an internal memory) or the like installed on a circuit substrate, includes a computer program that executes a prescribed computing operation based on an input signal, and can be implemented through a combination of hardware and software. In an illustrated form, the computing unit 16 is constituted as part of the control unit 17. It is naturally understood that some portions (such as a CPU) or all portions of the computing unit may be installed in a device (such as a driving device including the drive unit) other than the device including the control unit 17.

### [Concentration Measurement Process]

The computing unit 16 computes an absorbance using the detection signals from the transmitted light detector 8 and the incident light detector 9, and computes a proper absorptivity α₂ of the substance to be measured in the light emitted from the semiconductor light source 2 using the detection temperature from the temperature measuring element 10. Specifically, while a plurality of (seven) characteristic coefficients of the semiconductor light source 2 are stored in the memory 14 in advance, the computing unit 16 computes an absorbance A₂ using the detection signals from the transmitted light detector 8 and the incident light detector 9, and computes a so-called ratio α_{f} between the proper absorptivity α₂ and a compatible absorptivity α₁ of the substance to be measured in measurement, corresponding to a detection temperature Ta of the semiconductor light source 2 detected by the temperature measuring element 10, and calculates a concentration C by absorptiometry.

### [Concentration Calculation Process]

The computing unit 16 computes an absorbance A₁ in a compatible absorption wavelength based on an intensity I₀ of incident light not passing through the measuring cell 4 and an intensity I₁ of transmitted light passing through the substance to be measured in the measuring cell 4, and calculates the concentration C of the substance to be measured based on Beer-Lambert Law by a following formula (1), where α₁ is a compatible absorptivity of the substance to be measured, and L is an optical path length of the measuring cell 4. The compatible absorption wavelength is the wavelength at which the substance to be measured demonstrates highest absorbance, and the compatible absorptivity α₁ is a coefficient indicating the characteristic that the substance to be measured most efficiently absorbs the light in that wavelength. The term “compatible” means “necessary” for the substance to be measured actually used to be measurable, and the compatible absorptivity is, for example, an absorptivity which is derived with monochromatic light (assuming that the wavelength does not shift) and which is necessary for the substance to be measured to be measurable.

$${A}_{1} = - {log}_{10} ( {I}_{1} / {I}_{0} ) = {α}_{1} LC \qquad ( 1 )$$

The compatible absorptivity α₁ is determined by the substance to be measured and the compatible emission wavelength. Accordingly, when the semiconductor light source 2 is used, the emission wavelength changes as the state temperature changes and therefore, the absorbance also changes to A₂. In such cases, the computing unit 16 computes the absorptivity α₂ using the characteristic coefficient of the semiconductor light source 2 described later and the detection temperature of the semiconductor light source 2 from the temperature measuring element 10, and calculates the concentration C according to a formula (2) below. At this time, the absorbance A₂ is calculated from an intensity I₂ of transmitted light having a changed emission wavelength and passing through the substance to be measured in the measuring cell 4, according to a formula (3) below. The intensity of incident light at this time is assumed to be equivalent to the intensity I₀ described above.

$${A}_{2} = {α}_{2} LC \qquad ( 2 )$$

$${A}_{2} = - {log}_{10} ( {I}_{2} / {I}_{0} ) \qquad ( 3 )$$

The proper absorptivity α₂ is calculated according to formulas (4) and (5) below using the characteristic coefficient of the semiconductor light source 2 and the detection temperature (Ta) of the semiconductor light source 2 from the temperature measuring element 10. In calculation of the proper absorptivity α₂, the ratio α_{f} between the α₂ and the compatible absorptivity α₁, which forms the basis of the concentration calculation, is obtained from the characteristic coefficient specific to the semiconductor light source 2, and the proper absorptivity α₂ is calculated based on the calculated compatible absorptivity α₁ and the ratio α_{f}. In the present embodiment, following seven characteristic coefficients (first to seventh characteristic coefficients) are used as the characteristic coefficient required to calculate the ratio α_{f}. Description is given below on the assumption that the same semiconductor light source is used and the absorbance sensitivity indicates the degree of absorbance as the degree of light absorbing performance.

### <First Characteristic Coefficient>

### Specific Peak Wavelength (Default Peak A)

This refers to a specific peak wavelength when the semiconductor light source is measured at the reference temperature. Here, the reference temperature refers to the reference temperature set in advance within the range of normal temperature. This also applies to the reference temperature described below.

### <Second Characteristic Coefficient>

### Absorbance Sensitivity Calibration Ratio (Default Abs Ratio)

This refers to a ratio relative to the absorption coefficient calculated from the compatible peak wavelength and the specific peak wavelength of the substance to be measured using an absorbance spectrum of the substance to be measured. The compatible peak wavelength herein refers to the wavelength used to calculate a compatible absorption coefficient.

### <Third Characteristic Coefficient>

### Standard Sensitivity Calibration Ratio (Abs Standard Ratio)

This refers to a ratio between an absorption coefficient of the specific peak wavelength and the absorbance sensitivity calibration ratio, the absorption coefficient being calculated using a relationship between a standard peak wavelength at the reference temperature (hereinafter referred to as “standard peak wavelength”) and the absorptivity of the substance to be measured.

### <Fourth Characteristic Coefficient>

### Absorbance Temperature Coefficient (Abs Temp Para)

This refers to a relative coefficient between a temperature coefficient in the standard peak wavelength of the semiconductor light source and the absorptivity of the substance to be measured and a temperature coefficient in the absorbance sensitivity calibration ratio.

### <Fifth Characteristic Coefficient>

### Peak Wavelength Temperature Coefficient Ratio (Peak λ Temp Para)

This refers to a relative coefficient between a temperature coefficient in the standard peak wavelength of the semiconductor light source and a temperature coefficient in the specific peak wavelength.

### <Sixth Characteristic Coefficient>

### Proper Absorbance Temperature Coefficient (Abs Temp Span Para)

This refers to a temperature coefficient ratio calculated from the relationship between the absorbance temperature coefficient ratio (fourth characteristic coefficient) and the peak wavelength temperature coefficient ratio (fifth characteristic coefficient) in the compatible absorptivity.

### <Seventh Characteristic Coefficient>

### Proper Absorbance Sensitivity Coefficient (Conc Span Para)

This refers to an absorbance sensitivity coefficient of the absorptivity and the compatible absorptivity of the substance to be measured in specific peak wavelength at the reference temperature.

$${α}_{2} = {α}_{1} / {α}_{f} \qquad ( 4 )$$

where the compatible absorptivity α₁ is calculated by the above formula (1).

An authorized absorptivity that enables the substance to be measured to most efficiently absorb light refers to the compatible absorption coefficient. In calculation of the proper absorptivity α₂, when the temperature rises, the emission wavelength shifts to a long wavelength side, and when the substance to be measured is irradiated with the light of the shifted wavelength, the sensitivity (energy amount) decreases. To compensate for the decreased sensitivity, the proper absorptivity α₂ is calculated using α_{f} and the compatible absorptivity α₁ described later. Since the proper absorptivity α₂ is a compensated absorptivity, the value is applied to the formula (2) to calculate the proper concentration C.

The calculation method of α_{f} is described below.

$${α}_{f} = abs span ratio ( Ta ) \times mes ratio ( Ta ) \times conc ratio ( Ta ) \times abs temp span ratio \times default abs ratio \times conc span para / abs standard ratio \qquad ( 5 )$$

Here, while the ratio α_{f} is calculated by the above formula (5), “abs span ratio (Ta)”, “mes ratio (Ta)”, “conc ratio (Ta), and “abs temp span ratio” in the respective parameters are calculated according to formulas (5-1) to (5-10) below.

The formulas (5-1) to (5-10) are described below in order.

### (I) Abs Span Ratio (Ta): Specific Absorptivity Ratio (Variable) at State Temperature

$$abs span ratio ( Ta ) = ( ( abs ratio ( Ta ) - 1 ) \times abs temp para / abs standard ratio + 1 ) \times abs standard ratio \qquad ( 5 - 1 )$$

where

$$( A ) abs ratio ( Ta ) = abs ratio a ( Ta ) \times {( real peak λ ( Ta ) )}^{4} + abs ratio b ( Ta ) \times {( real peak λ ( Ta ) )}^{3} + abs ratio c ( Ta ) \times {( real peak λ ( Ta ) )}^{2} + abs ratio d ( Ta ) \times real peak λ ( Ta ) + abs ratio e ( Ta ) \qquad ( 5 - 2 )$$

Herein, respective parameters in the formula (5-2) are calculated by following formulas (5-2-1) to (5-2-5), and (5-3).

$$abs ratio a ( Ta ) = ( ka 1 ) \times {( Ta )}^{4} + ( ka 2 ) \times {( Ta )}^{3} + ( ka 3 ) \times {( Ta )}^{2} + ( ka 4 ) \times ( Ta ) + ( ka 5 ) \qquad ( 5 - 2 - 1 )$$

$$abs ratio b ( Ta ) = ( kb 1 ) \times {( Ta )}^{4} + ( kb 2 ) \times {( Ta )}^{3} + ( kb 3 ) \times {( Ta )}^{2} + ( kb 4 ) \times ( Ta ) + ( kb 5 ) \qquad ( 5 - 2 - 2 )$$

$$abs ratio c ( Ta ) = ( kc 1 ) \times {( Ta )}^{4} + ( kc 2 ) \times {( Ta )}^{3} + ( kc 3 ) \times {( Ta )}^{2} + ( kc 4 ) \times ( Ta ) + ( kc 5 ) \qquad ( 5 - 2 - 3 )$$

$$abs ratio d ( Ta ) = ( kd 1 ) \times {( Ta )}^{4} + ( kd 2 ) \times {( Ta )}^{3} + ( kd 3 ) \times {( Ta )}^{2} + ( kd 4 ) \times ( Ta ) + ( kd 5 ) \qquad ( 5 - 2 - 4 )$$

$$abs ratio e ( Ta ) = ( ke 1 ) \times {( Ta )}^{4} + ( ke 2 ) \times {( Ta )}^{3} + ( ke 3 ) \times {( Ta )}^{2} + ( ke 4 ) \times ( Ta ) + ( ke 5 ) \qquad ( 5 - 2 - 5 )$$

where ka1 to ka5, kb1 to kb5, kc1 to kc5, kd1 to kd5, and ke1 to ke5 are constants.

$$( B ) real peak λ ( Ta ) = \{ \{ ( real peak λ a ( Ta ) \times {( peak λ ( Ta ) )}^{2} + real peak λ b ( Ta ) \times peak λ ( Ta ) + real peak λ c ( Ta ) ) - 1 \} \times peak λ temp para + 1 \} \times default peak λ \qquad ( 5 - 3 )$$

where respective parameters in the formula (5-3) are calculated by following formulas (5-3-1) to (5-3-5), and (5-4).

$$real peak λ a ( Ta ) = ( wa 1 ) \times {( Ta )}^{2} + ( wa 2 ) \times Ta + ( wa 3 ) \qquad ( 5 - 3 - 1 )$$

$$real peak λ b ( Ta ) = ( wb 1 ) \times {( Ta )}^{2} + ( wb 2 ) \times Ta + ( wb 3 ) \qquad ( 5 - 3 - 2 )$$

$$real peak λ c ( Ta ) = ( wc 1 ) \times {( Ta )}^{2} + ( wc 2 ) \times Ta + ( wc 3 ) \qquad ( 5 - 3 - 3 )$$

where wa1 to wa3, wb1 to wb3, and wc1 to wc3 are constants.

$$( C ) peak λ ( Ta ) = \{ ( z 1 ) \times {( Ta )}^{2} + ( z 2 ) \times ( Ta ) + ( z 3 ) \} \times ( default peak λ ) \qquad ( 5 - 4 )$$

where Z1 to Z3 are constants.

### (II) Mes Ratio (Ta): Specific Absorptivity Ratio at Reference Temperature

$$mes ratio ( Ta ) = mes ratio a ( To ) \times {( real peak λ ( Ta ) )}^{3} + mes ratio b ( To ) \times {( real peak λ ( Ta ) )}^{2} + mes ratio c ( To ) \times real peak {λ ( Ta )}^{3} + mes ratio d ( To ) \qquad ( 5 - 5 )$$

where respective parameters in the formula (5-5) are calculated by following formulas (5-5-1) to (5-5-4).

$$( A ) mes ratio a ( To ) = ( ma 1 ) \times {( To )}^{3} + ( ma 2 ) \times {( To )}^{2} + ( ma 3 ) \times ( To ) + ( ma 4 ) \qquad ( 5 - 5 - 1 )$$

$$( B ) mes ratio b ( To ) = ( mb 1 ) \times {( To )}^{3} + ( mb 2 ) \times {( To )}^{2} + ( mb 3 ) \times ( To ) + ( mb 4 ) \qquad ( 5 - 5 - 2 )$$

$$( C ) mes ratio c ( To ) = ( m c 1 ) \times {( To )}^{3} + ( m c 2 ) \times {( To )}^{2} + ( m c 3 ) \times ( To ) + ( m c 4 ) \qquad ( 5 - 5 - 3 )$$

$$( D ) mes ratio d ( To ) = ( md 1 ) \times {( To )}^{3} + ( md 2 ) \times {( To )}^{2} + ( md 3 ) \times ( To ) + ( md 4 ) \qquad ( 5 - 5 - 4 )$$

where ma1 to ma4, mb1 to mb4, mc1 to mc4, md1 to md4 are constants, and real peak λ(Ta) is calculated from the formula (5-3).

### (III) Conc Ratio (Ta): Compatible Absorptivity Ratio at Reference Temperature

$$conc ratio ( Ta ) = conc ratio a ( To ) \times {( real peak λ ( Ta ) )}^{3} + conc ratio b ( To ) \times {( real peak λ ( Ta ) )}^{2} + conc ratio c ( To ) \times real peak λ ( Ta ) + conc ratio d ( To ) \qquad ( 5 - 6 )$$

where respective parameters except real peak λ(Ta) in the formula (5-6) are calculated by following formulas (5-6-1) to (5-6-4), and real peak λ(Ta) is calculated from the formula (5-3)

$$( A ) conc ratio a ( To ) = ( na 1 ) \times {( To )}^{3} + ( na 2 ) \times {( To )}^{2} + ( na 3 ) \times ( To ) + ( na 4 ) \qquad ( 5 - 6 - 1 )$$

$$( B ) conc ratio b ( To ) = ( nb 1 ) \times {( To )}^{3} + ( nb 2 ) \times {( To )}^{2} + ( nb 3 ) \times ( To ) + ( nb 4 ) \qquad ( 5 - 6 - 2 )$$

$$( C ) conc ratio c ( To ) = ( nc 1 ) \times {( To )}^{3} + ( nc 2 ) \times {( To )}^{2} + ( nc 3 ) \times ( To ) + ( nc 4 ) \qquad ( 5 - 6 - 3 )$$

$$( D ) conc ratio d ( To ) = ( nd 1 ) \times {( To )}^{3} + ( nd 2 ) \times {( To )}^{2} + ( nd 3 ) \times ( To ) + ( nd 4 ) \qquad ( 5 - 6 - 4 )$$

where na1 to na4, nb1 to nb4, nc1 to nc4, and nd1 to nd4 are constants, and real peak λ(Ta) is calculated from the formula (5-3).

### (IV) Abs Temp Span Ratio: Specific Absorptivity Ratio in State Temperature to Reference Temperature

$$abs temp span ratio ( Ta ) = ( ( ( ( abs ratio ( To ) - 1 ) \times abs temp para / abs standard ratio + 1 ) / ( ( abs ratio ( Ta ) - 1 ) \times abs temp para / abs standard ratio + 1 ) ) - 1 ) \times abs temp span para + 1 \qquad ( 5 - 7 )$$

where abs ratio (Ta) is calculated from the formula (5-2), and abs ratio (To) is calculated from a following formula (5-8).

$$( A ) abs ratio ( To ) = abs ratio a ( To ) \times {( real peak λ ( To ) )}^{4} + abs ratio b ( To ) \times {( real peak λ ( To ) )}^{3} + abs ratio c ( To ) \times {( real peak λ ( To ) )}^{2} + abs ratio d ( To ) \times real peak λ ( To ) + abs ratio e ( To ) \qquad ( 5 - 8 )$$

where respective parameters in the formula (5-8) are calculated by following formulas (5-8-1) to (5-8-5).

$$( B ) abs ratio a ( To ) = ( ka 1 ) \times {( To )}^{4} + ( ka 2 ) \times {( To )}^{3} + ( ka 3 ) \times {( To )}^{2} + ( ka 4 ) \times ( To ) + ( ka 5 ) \qquad ( 5 - 8 - 1 )$$

$$( C ) abs ratio b ( To ) = ( kb 1 ) \times {( To )}^{4} + ( kb 2 ) \times {( To )}^{3} + ( kb 3 ) \times {( To )}^{2} + ( kb 4 ) \times ( To ) + ( kb 5 ) \qquad ( 5 - 8 - 2 )$$

$$( D ) abs ratio c ( To ) = ( kc 1 ) \times {( To )}^{4} + ( kc 2 ) \times {( To )}^{3} + ( kc 3 ) \times {( To )}^{2} + ( kc 4 ) \times ( To ) + ( kc 5 ) \qquad ( 5 - 8 - 3 )$$

$$( E ) abs ratio d ( T o ) = ( kd 1 ) \times {( To )}^{4} + ( kd 2 ) \times {( To )}^{3} + ( kd 3 ) \times {( To )}^{2} + ( kd 4 ) \times ( To ) + ( kd 5 ) \qquad ( 5 - 8 - 4 )$$

$$( F ) abs ratio e ( To ) = ( ke 1 ) \times {( To )}^{4} + ( ke 2 ) \times {( To )}^{3} + ( ke 3 ) \times {( To )}^{2} + ( ke 4 ) \times ( To ) + ( ke 5 ) \qquad ( 5 - 8 - 5 )$$

where ka1 to ka5, kb1 to kb5, kc1 to kc5, kd1 to kd5, and ke1 to ke5 are constants.
   (IV-1) Here, Real Peak λ(to) is Calculated by a Following Formula (5-9).

$$( A ) real peak λ ( To ) = \{ \{ ( real peak λ a ( To ) \times {( peak λ ( To ) )}^{2} + real peak λ b ( To ) \times peak λ ( To ) + real peak λ c ( To ) ) - 1 \} \times peak λ temp\_para + 1 \} \times default peak λ \qquad ( 5 - 9 )$$

In the formula (5-9), real peak λa (To), real peak λb (To), and real peak λc (To) are calculated from following formulas (5-9-1) to (5-9-3), respectively.

$$( a 1 ) real peak λ a ( To ) = ( wa 1 ) \times {( To )}^{2} + ( wa 2 ) \times To + ( wa 3 ) \qquad ( 5 - 9 - 1 )$$

$$( a 2 ) real peak λ b ( To ) = ( wb 1 ) \times {( To )}^{2} + ( wb 2 ) \times To + ( wb 3 ) \qquad ( 5 - 9 - 2 )$$

$$( a 3 ) real peak λ c ( To ) = ( wc 1 ) \times {( To )}^{2} + ( wc 2 ) \times To + ( wc 3 ) \qquad ( 5 - 9 - 3 )$$

where wa1 to wa3, wb1 to wb3, and wc1 to wc3 are constants.

In the formula (5-9), peak λ(To) is calculated from a following formula (5-10).

$$( a 4 ) peak λ ( To ) = \{ ( z 1 ) \times {( To )}^{2} + ( z 2 ) \times ( To ) + ( z 3 ) \} \times ( default peak λ ) \qquad ( 5 - 10 )$$

where Z1 to Z3 are constants.

As described above, the concentration C is calculated by the formulas (1) to (5). In the embodiment disclosed, the computing unit 16 receives the state temperature information from the temperature measuring element 10 in real time and performs computation according to the formulas (1) to (5). However, the results of computation by the formulas (1) to (5) at a plurality of state temperatures may be stored in advance in the memory as a table, and the concentration may be automatically calculated upon reception of an actually detected state temperature.

When the concentration C is treated as a standard state concentration Co, a measurement temperature Tc (° C.) and a state pressure Pa (kPa) of the substance to be measured are detected by the temperature sensor 11 and the pressure sensor 12, respectively, and concentration conversion is performed according to a following formula (6).

$$Co = C \times \{ ( 273.15 + Tc ) / 273.15 \} \times \{ 101.32 / ( 101.32 + Pa ) \} \qquad ( 6 )$$

### Example

In this example, a ratio α_{f} to the compatible absorptivity α₁ (ozone gas) when the detection temperature (Ta) of the semiconductor light source 2 from the temperature measuring element 10 changes in four stages of 15° C., 25° C., 35° C., and 45° C. is calculated by computation of the formula (5) using the characteristic coefficient of the semiconductor light source 2 and the detection temperature of the semiconductor light source 2 from the temperature measuring element 10 in the computing unit 16, and the compatible absorptivity α₁ at the state temperature in measurement and the ratio α_{f} calculated as above are substituted into the formula (4) to compute the proper absorptivity α₂. Then, based on the absorbance A₂, the optical path length L of the measuring cell 4, and the proper absorptivity α₂ in measurement, the concentration C is calculated according to the formula (2).

In FIG. 3, (A) shows a characteristic indicating the relationship between the concentration C, which is calculated by using the semiconductor light source and based on the concentration calculation method described above and which is converted to an ozone gas concentration value, and the detection temperature (Ta) of the temperature measuring element 10. In FIG. 3, (B) shows a characteristic indicating the relationship between the concentration C, which is calculated by using the semiconductor light source under conditions where the first to seventh characteristic coefficients are not applied and which is converted to an ozone gas concentration value, and the detection temperature (Ta) of the temperature measuring element 10.

A characteristic graph (C) is a characteristic graph obtained by computing the absorbance A₁ by using a mercury lamp as a light source and using monochromatic light compatible with the absorptivity of ozone gas that is the substance to be measured, based on the intensity I₀ of incident light not passing through the measuring cell 4 and the intensity I₁ of transmitted light passing through the ozone gas in the measuring cell 4, and calculating the concentration C of the substance to be measured according to the formula (1) based on the compatible absorptivity α₁, which forms the basis of the concentration calculation based on Beer-Lambert law.

The characteristic graph (C) is calculated according to the formula (1) on the assumption that the absorbance A₁ does not change with the change in light source temperature. As the temperature of the light source detected by the temperature measuring element rises, the ozone gas concentration gradually increases. On the contrary, as shown by the characteristic graph (B), when the absorbance A changes to A₂ with the change in light source temperature and the first to seventh characteristic coefficients are not applied, the ozone gas concentration gradually decreases as the temperature of the light source detected by the temperature measuring element rises, which indicates that the measurement accuracy deteriorates.

Accordingly, when the absorbance A₁ changes to A₂ with the change in light source temperature and the first to seventh characteristic coefficients are applied, almost no increase in ozone gas concentration is observed as the temperature of the light source detected by the temperature measuring element rises as shown by the characteristic graph (A), and this indicate that the measurement accuracy is high.

### Effects of Embodiments

Thus, according to the optical analysis device in the present embodiment, it is possible to improve the accuracy of concentration measurement without performing temperature control to keep the state temperature of the semiconductor light source at constant temperature by using a heating element or the like. In in-line optical analysis devices directly interconnected to the main line in the manufacturing process, it is common practice to remove the in-line optical analysis devices from the interconnection for calibration in their manufacturer sites because sensitivity calibration in concentration comparison has not been possible. However, in the present embodiment, measurement can be performed in a shorter time because the measurement is possible without removing the analysis devices.

When the state temperature of the semiconductor light source rises in measurement, the emission wavelength shifts to the long wavelength side, and when the substance to be measured is irradiated with the light of the shifted wavelength, the sensitivity (energy amount) decreases. To compensate for the decreased sensitivity, the proper absorptivity α₂ is calculated using the α_{f} and the compatible absorptivity α₁, and the compensated proper absorptivity α₂ is applied to the formula (2) to calculate the proper concentration C, so that more accurate measurement can be performed.

In the embodiment disclosed, more accurate measurement can be performed when following processes are performed. The following measurements are performed on different substances to be measured (first and second substances to be measured) using the optical analysis device of the present embodiment. While the concentration of the first substance to be measured is constant, the state temperature of the semiconductor light source is optionally changed by a drive power supply of the semiconductor light source (the emission wavelength is changed so that two emission wavelengths are specified), and the concentrations (Cx) are calculated from two or more absorptivity (αx) values and absorbance (Ax) values corresponding to the respective emission wavelengths. The proper absorptivity (α₂) values and the absorbance (A₂) values of the substance to be measured in the respective concentrations are computed based on absorptiometry, and first concentrations C1 corresponding to the respective emission wavelengths are calculated from the proper absorptivity (α₂) values and the absorbance (A₂) values. While the concentration of the second substance to be measured is constant, the state temperature of the semiconductor light source is optionally changed by the drive power supply of the semiconductor light source (the emission wavelength is changed so that two emission wavelengths are specified), and the concentrations (Cx) are calculated from two or more absorptivity (αx) values and absorbance (Ax) values corresponding to the respective emission wavelengths. The proper absorptivity (α2) values and the absorbance (A₂) values of the substance to be measured in the respective concentrations are computed based on absorptiometry, and second concentrations C2 corresponding to the respective emission wavelengths are calculated from the proper absorptivity (α₂) values and the absorbance (A₂) values. As a result, different measurement substance concentrations C₁ and C₂ are obtained. By calculating a degree of contamination from the different measurement substance concentrations C₁ and C₂ and performing zero point calibration, the measurement accuracy can be enhanced. Note that αx, Ax, Cx, α₂, and A₂ are defined as follows.
αx: any absorptivity corresponding to a pertinent emission wavelength
Ax: any absorbance corresponding to the pertinent emission wavelength
Cx: concentration calculated from any absorptivity and absorbance corresponding to the pertinent emission wavelength
α₂: proper absorptivity at the time
A₂: absorbance in the proper absorptivity at the time

### INDUSTRIAL APPLICABILITY

### [Application to Measurement Field]

By optionally changing the emission wavelength of the semiconductor light source by the drive power supply, concentration error can be discriminated using the relationship between the absorptivity of the substance to be measured and incompatible wavelengths in absorptiometry. In fluorescence analysis, the present invention is applicable to discrimination of concentration error by scanning irradiation wavelength and obtaining reflected fluorescence intensity, and is also applicable to qualitative and quantitative analysis.

### [Application to Sterilization Field]

In the field of sterilization and disinfection by irradiation of ultraviolet wavelengths, it is known that the effect greatly varies depending on the wavelength range of light. The present invention is applicable to monitoring emission wavelength for appropriate wavelength control by optionally controlling the emission wavelength of the semiconductor light source by the drive power supply, and detecting the state temperature of the semiconductor light source with the temperature measuring element (detecting a potential difference (forward voltage) between the anode electrode and the cathode electrode of the diode constituting the semiconductor light source 2).

1-12. (canceled)

13. An optical analysis device, comprising:
a measuring cell having a flow channel for a substance to be measured to flow;
a semiconductor light source that emits light with a wavelength compatible with an absorptivity of the substance to be measured;
a transmission window that transmits light from the semiconductor light source;
a transmitted light detector that detects transmitted light in the measuring cell, the transmitted light being the light coming from the semiconductor light source and passing through the transmission window;
an incident light detector that detects incident light not passing through the measuring cell;
a distributor that branches the light into the transmitted light and the incident light;
a temperature measuring element that measures a state temperature of the semiconductor light source;
a temperature sensor that measures temperature of the substance to be measured;
a pressure sensor that measures pressure of the substance to be measured; and
a drive unit that lights the semiconductor light source, wherein
a characteristic coefficient of the semiconductor light source is stored in a memory in advance, and the absorptivity of the substance to be measured during measurement is computed in a computing unit by using detected temperature of the semiconductor light source from the temperature measuring element, and a concentration of the substance to be measured is calculated by absorptiometry.

14. An optical analysis device, comprising:
a measuring cell having a flow channel for a substance to be measured to flow;
a semiconductor light source that emits light with a wavelength compatible with an absorptivity of the substance to be measured;
a transmission window that transmits light from the semiconductor light source;
a transmitted light detector that detects transmitted light in the measuring cell, the transmitted light being the light coming from the semiconductor light source and passing through the transmission window;
an incident light detector that detects incident light not passing through the measuring cell;
a distributor that branches the light into the transmitted light and the incident light;
a temperature sensor that measures temperature of the substance to be measured;
a pressure sensor that measures pressure of the substance to be measured; and
a drive unit that lights the semiconductor light source, wherein
a characteristic coefficient of the semiconductor light source is stored in a memory in advance, the absorptivity of the substance to be measured during measurement is computed in a computing unit by using detected temperature of the semiconductor light source, and a concentration of the substance to be measured is calculated by absorptiometry.

15. The optical analysis device of claim 13, wherein the distributor used to branch the light from the semiconductor light source is a beam splitter or a diffraction grating.

16. The optical analysis device of claim 14, wherein the distributor used to branch the light from the semiconductor light source is a beam splitter or a diffraction grating.

17. The optical analysis device of claim 13, wherein the transmission window is made of a sapphire glass material or a quartz glass material.

18. The optical analysis device of claim 14, wherein the transmission window is made of a sapphire glass material or a quartz glass material.

19. The optical analysis device of claim 13, wherein the temperature measuring element of the semiconductor light source detects the state temperature of a mounting pad for the semiconductor light source by using any one of a thermometer resistor, a thermistor, a thermocouple, a semiconductor temperature measuring element, and an infrared sensor.

20. The optical analysis device of claim 13, wherein the temperature measuring element of the semiconductor light source is arranged on a substrate on which the semiconductor light source to detect the state temperature is mounted.

21. The optical analysis device of claim 13, wherein the temperature measuring element of the semiconductor light source is arranged adjacent to a mounting pad for the semiconductor light source, by using any one of a thermometer resistor, a thermistor, a thermocouple, a semiconductor temperature measuring element, and an infrared sensor, to detect the state temperature through heat transfer through radiant heat or through contact via a substance with high thermal conductivity.

22. The optical analysis device of claim 13, wherein the temperature measuring element is arranged adjacent to a substrate on which the semiconductor light source is mounted, and is configured to detect the state temperature by using any one of a thermometer resistor, a thermistor, a thermocouple, a semiconductor temperature measuring element, and an infrared sensor through heat transfer through radiant heat or through contact via a substance with high thermal conductivity.

23. The optical analysis device of claim 13, wherein
the memory stores at least one characteristic coefficient out of
a first characteristic coefficient of the semiconductor light source that is a specific peak wavelength when the semiconductor light source is measured at a reference temperature,
a second characteristic coefficient of the semiconductor light source that is an absorbance sensitivity calibration ratio indicating a ratio relative to an absorption coefficient calculated from a compatible peak wavelength and the specific peak wavelength of the substance to be measured,
a third characteristic coefficient of the semiconductor light source that is a standard sensitivity calibration ratio indicating a ratio between an absorption coefficient of the specific peak wavelength, calculated using a relationship between a standard peak wavelength at the reference temperature and the absorption coefficient of the substance to be measured, and the absorbance sensitivity calibration ratio,
a fourth characteristic coefficient of the semiconductor light source that is an absorbance temperature coefficient indicating a relative coefficient between the standard peak wavelength of the semiconductor light source at the reference temperature and a temperature coefficient in the absorptivity of the substance to be measured,
a fifth characteristic coefficient of the semiconductor light source that is a peak wavelength temperature coefficient ratio indicating a relative coefficient between a temperature coefficient in the standard peak wavelength of the semiconductor light source and a temperature coefficient in the specific peak wavelength,
a sixth characteristic coefficient of the semiconductor light source that is a proper absorbance temperature coefficient indicating a temperature coefficient ratio calculated from a relationship between an absorbance temperature coefficient ratio in the compatible absorptivity that is an authorized absorptivity enabling the substance to be measured to most efficiently absorb light and the peak wavelength temperature coefficient ratio, and
a seventh characteristic coefficient of the semiconductor light source that is a proper absorbance sensitivity coefficient indicating an absorbance sensitivity coefficient of the absorptivity and the compatible absorptivity of the substance to be measured in the specific peak wavelength at the reference temperature.

24. The optical analysis device of claim 23, wherein
the computing unit computes the absorptivity of the substance to be measured corresponding to an emission wavelength during measurement by using the state temperature of the semiconductor light source and the characteristic coefficient of the semiconductor light source, and
the temperature measuring element of the semiconductor light source is arranged adjacent to a mounting pad for the semiconductor light source, by using any one of a thermometer resistor, a thermistor, a thermocouple, a semiconductor temperature measuring element, and an infrared sensor, to detect the state temperature through heat transfer through radiant heat or through contact via a substance with high thermal conductivity.

25. The optical analysis device of claim 13, wherein electric power of a drive power supply for the semiconductor light source is varied to optionally change the state temperature of the semiconductor light source and to control an emission wavelength, and a different concentration of the substrate to be measured and a degree of contamination of the transmission window are computed from the obtained absorptivity to perform zero point calibration.

26. The optical analysis device of claim 13, wherein the semiconductor light source is attachable and detachable.

27. The optical analysis device of claim 14, wherein electric power of a drive power supply for the semiconductor light source is varied to optionally change the state temperature of the semiconductor light source and to control an emission wavelength, and a different concentration of the substrate to be measured and a degree of contamination of the transmission window are computed from the obtained absorptivity to perform zero point calibration.

28. The optical analysis device of claim 14, wherein the semiconductor light source is attachable and detachable.
